(19) United States
(12) Patent Application Publication
(10) Pub. No.: US 2015/0332143 A1
(43) Pub. Date: Nov. 19, 2015

(54) PROVIDING RELEVANT KNOWLEDGE TO A USER BASED ON THE REQUIREMENTS OF THE USER

(71) Applicant: HCL Technologies Ltd., Noida (IN)

(72) Inventors: Navin Saini, Noida (IN); Vishal Chaudhary, Noida (IN); Akhilesh Kumar Gupta, Noida (IN)

(73) Assignee: HCL TECHNOLOGIES LTD., Noida (IN)

(21) Appl. No.: 14/713,649

(22) Filed: May 15, 2015

(30) Foreign Application Priority Data
May 16, 2014 (IN) 1307/DEL/2014

(51) Int. Cl. G06N 5/02

(52) U.S. Cl. CPC G06N 5/022

(57) ABSTRACT

Providing relevant knowledge to a user based on the requirements of the user. This invention relates to management of knowledge present with an organization and more particularly to making the knowledge present within an organization available to employees at the right time. The principal object of this invention is to provide a method and system for providing relevant knowledge to a user seamlessly at every specific phase of his/her project development. Another object of the invention is to provide a method and system for providing the relevant knowledge of project phase and technology to a user who is a part of the project, without searching.

### CROSS-REFERENCE TO RELATED APPLICATIONS

This application claims priority to Indian application no. 1307/DEL/2014 filed on May 16, 2014, the complete disclosure of which, in its entirety, is herein incorporated by reference.

### FIELD OF INVENTION

This invention relates to management of knowledge present with an organization and more particularly to making the knowledge present within an organization available to employees at the right time.

### BACKGROUND OF INVENTION

Currently, the knowledge and know-how present within an organization is important. There are knowledge management methodologies and systems, which serve as a repository for the knowledge present within the organization. These repositories may enable uploading of the knowledge within the organization, wherein the knowledge may be in the form of technical documents, white papers, presentations, reusable components, tools, software code, development methodologies and so on.

A user may search the repository and retrieve material based on the search parameter provided by the user. The repositories may also enable the user to tag and/or rank the knowledge. The onus is on the user to decide an item of knowledge that he may require. The user may further have to decide on a suitable search parameter based on his requirements.

The chances of the user not being able to access and use the right item of knowledge are significant. This may result in losses to the company, as the user is unable to access the right item at the appropriate time.

### OBJECT OF INVENTION

The principal object of this invention is to provide a method and system for providing relevant knowledge to a user seamlessly at every specific phase of his/her project development.

Another object of the invention is to provide a method and system for providing the relevant knowledge of project phase and technology to a user who is a part of the project, without searching.

### SUMMARY OF INVENTION

Accordingly the invention provides a method for providing knowledge present in an organization to at least one employee, the method comprising of checking by a Knowledge Management (KM) tool if at least one item of knowledge is to be provided to a user, on detecting a change in information of the user; and providing at least one item of knowledge to the user by the KM tool, on the KM tool detecting at least one item of knowledge that is to be provided to a user.

Also, provided herein is a knowledge management system for providing knowledge present in an organization to at least one employee, the system configured for checking if at least one item of knowledge is to be provided to a user, on detecting a change in information of the user; and providing at least one item of knowledge to the user, on the system detecting at least one item of knowledge that is to be provided to a user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 depicts a computer network present within an organization, according to embodiments as disclosed herein;

FIG. 2 depicts a system for enabling at least one user to upload at least one item of knowledge to a knowledge database repository, according to embodiments as disclosed herein;

FIG. 3 is a flowchart illustrating the process of at least one user uploading at least one item of knowledge to a knowledge database repository, according to embodiments as disclosed herein;

FIG. 4 depicts a system for enabling at least one user to access an item from the knowledge database repository, according to embodiments as disclosed herein; and

FIG. 5 is a flowchart illustrating the process of providing at least one item of knowledge from a knowledge database repository to a user automatically, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

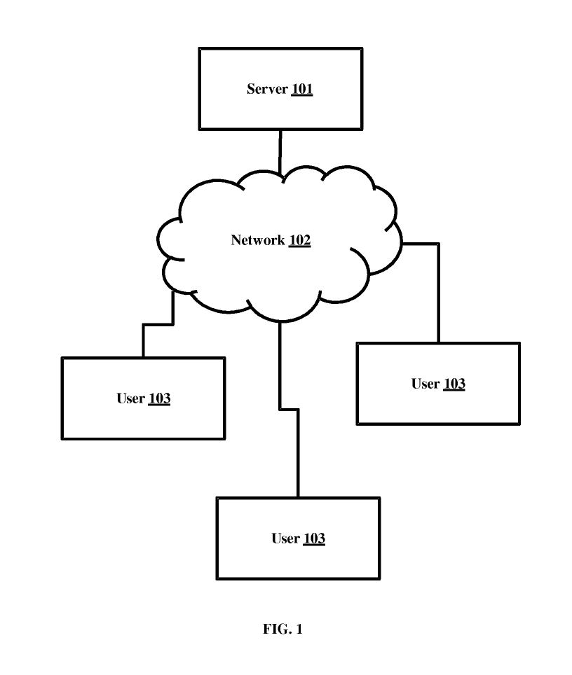

The embodiments herein disclose a method and system for providing relevant knowledge to a user seamlessly at every specific phase of his/her project development. Referring now to the drawings, and more particularly to FIGS. 1 through 5, where similar reference characters denote corresponding features consistently throughout the figures, there are shown preferred embodiments.

FIG. 1 depicts a computer network present within an organization, according to embodiments as disclosed herein. The network, as depicted comprises of at least one server 101 connected to a plurality of users 103 through a network 102. The network 102 may be a network internal to the organization such as a Local Area Network (LAN), Wide Area Network (WAN) and so on. The network 102 may be the Internet. The network 102 may comprise of a means to enable a user 103 to link to the server 102 using a remote access means such as Virtual Private Network (VPN) and so on. The user 103 may access the server 101 using a device such as a laptop, computer, phone, tablet, PDA (Personal Digital Assistant) and so on. The server 101 may be any suitable server which may be used within an organization such as a Windows Server, a Microsoft SQL Server, Sharepoint server and so on.

The server 101 may enable at least one user 103 to upload items to the server 101. The server 101 may authenticate the user 103, before permitting the user 103 to upload the items. The server 101 may also check if the user 103 has the requisite permissions to upload items to the server 101. Examples of the items may be a checklist that may be used while performing a task, a reusable component that may be used by other authorized users present in the organization, knowledge snippets (which may be at least one of a whitepaper, a technical article, a short note, a presentation, images, audio snippets, video snippets or any other suitable means of knowledge dissemination). The server 101 may enable at least one other user 103 to authenticate the item. This at least one other user 103 may be a subject matter expert, and may be a part of the organization. The subject matter expert may be an external person, with the requisite permissions to check and approve the items. This at least one other user 103 may be a user to whom the user who uploaded the item reports or any other person authorized by an administrator of the server 101. The server 101 may further categorize the item into at least one hierarchy. For example, the hierarchy may be based on the technology domain to which the item belongs, the lifecycle phase of a PDLC (Product Development Life Cycle) to which the item belongs, the type of item and so on. The server 101 may then store the item in a suitable location, such as a database, memory and so on. The server 101 may check if the item is related to knowledge present in at least one external source, wherein the external source may be the Internet (repositories such as patent databases such as Google Patents, USPTO, EPO, WIPO and so on), another knowledge management system, a whitepaper repository (such as IEEE Xplore, Google Scholar and so on) and so on. The server 101 may generate at least one keyword based on the item and may perform the search on the external source using the generated keywords. The server 101 may also store items from the external source along with the item as uploaded by the user 103.

The server 101 further makes the stored items available to other users 103, based on their requirement. The server 101 may push the items to the user 103, based on a plurality of factors such as the technology that the user is currently working on, the technology that the user may be working on in the future, the current phase of the PDLC, the skill levels of the user 103, the previous employment history of the user 103 (such as the previous items that the user 103 has been exposed to, the educational history of the user 103, the previous projects that the user 103 has worked on, the previous organizations that the user has worked in, the time the employee has been employed with the current organization and so on), the role played by the user 103 in the project and so on. Information such as the technology that the user is currently working on, the technology that the user may be working on in the future, the current phase of the PDLC, the role played by the user 103 in the project may be provided by at least one person to whom the user reports (such as his reporting manager, team lead and so on). The server 101 may fetch information such as the skill levels of the user 103, the previous employment history of the user 103 (such as the previous items that the user 103 has been exposed to, the educational history of the user 103, the previous projects that the user 103 has worked on, the previous organizations that the user has worked in, the time the employee has been employed with the current organization and so on), the role played by the user 103 in the project and so on from at least one employee database, wherein the employee database may comprise of information from all the employees. The server 101 may provide a screening means, wherein at least one person to whom the user reports verifies the item, before the server 101 provides the item to the user 103. The at least one person to whom the user reports may also verify whether the item may face any patent related issues (such as the technology disclosed in the item infringes a patent not belonging to the organization, the technology not having freedom to operate within a specific jurisdiction and so on).

The server 101 may enable the user 101 to search for item(s) using at least one keyword/keyphrase. Based on the keyword/keyphrase, the server 101 may provide at least one result from the items present in the server 101. In an embodiment herein, the server 101 may consider factors such as the technology that the user is currently working on, the technology that the user may be working on in the future, the current phase of the PDLC, the skill levels of the user 103, the previous employment history of the user 103 (such as the previous items that the user 103 has been exposed to, the educational history of the user 103, the previous projects that the user 103 has worked on, the previous organizations that the user has worked in, the time the employee has been employed with the current organization and so on), the role played by the user 103 in the project and so on, before providing the results to the user. Information such as the technology that the user is currently working on, the technology that the user may be working on in the future, the current phase of the PDLC, the role played by the user 103 in the project may be provided by the user 103. The server 101 may fetch information such as the skill levels of the user 103, the previous employment history of the user 103 (such as the previous items that the user 103 has been exposed to, the educational history of the user 103, the previous projects that the user 103 has worked on, the previous organizations that the user has worked in, the time the employee has been employed with the current organization and so on), the role played by the user 103 in the project and so on from at least one employee database.

The server 101 may enable the user 103 receiving the item(s) to verify that he has completed the course. The user 103 may verify using a signature (which may be an electronic signature, where he writes his name, the current date and so on).

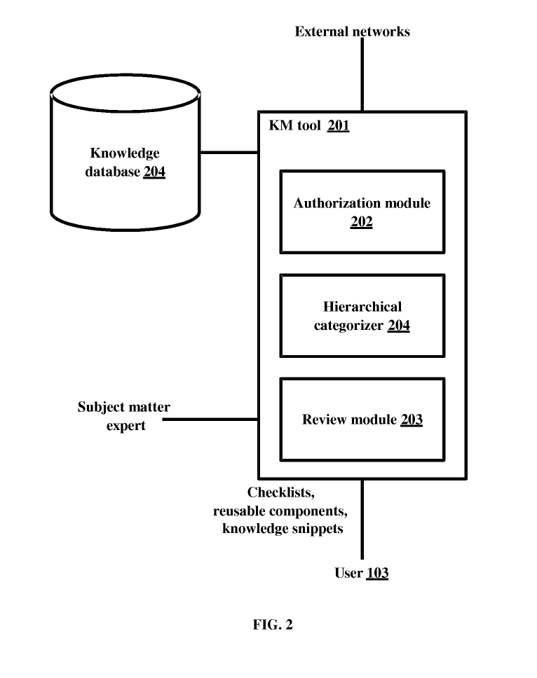

FIG. 2 depicts a system for enabling at least one user to upload at least one item of knowledge to a knowledge database repository, according to embodiments as disclosed herein. The system comprises of a KM (Knowledge Management) tool 201 and a knowledge database 204. The KM tool 201 further comprises of an authorization module 202, a review module 203 and a hierarchical categorizer 204. The KM tool 201 may be connected to at least one external network which acts as an external source. The external source may be the Internet (repositories such as patent databases such as Google Patents, USPTO, EPO, WIPO and so on), another knowledge management system, a whitepaper repository (such as IEEE Xplore, Google Scholar and so on) and so on.

The KM tool 201 may enable at least one user 103 to upload items to the knowledge database 204. On a user 103 connecting to the KM tool 201, the authorization module 202 may authenticate the user 103. The authorization module 202 may check if the user 103 has the requisite permissions to upload items to the server 101. On the user 103 being authenticated, the user 103 uploads at least one item to the KM tool 101. The review module 203 may enable at least one other user 103 to authenticate the item. The review module 203 and the authorization module 202 may authenticate this at least one other user. The review module 203, depending on the item, may identify at least one subject matter expert, based on information present in a suitable source such as an employee database, prior history and so on. The review module 203 may send a notification to the subject matter expert indicating that there is an item that is waiting for review. On the subject matter expert reviewing the item and authorizing the upload of the item, the review module 203 forwards the item to the hierarchical categorizer 204. If the subject matter expert reviews the item and does not authorize the upload of the item, the review module 203 may send an indication to the user 103. The review module 203 may also provide at least one reason, if provided by the subject matter expert on why the item was not authorized. The hierarchical categorizer 204 may categorize the item into at least one hierarchy. For example, the hierarchy may be based on the technology domain to which the item belongs, the lifecycle phase of a PDLC (Product Development Life Cycle) to which the item belongs, the type of item and so on. The KM tool 201 may then store the item in the knowledge database 204. The knowledge database 204 may be located remotely from the KM tool 101. The knowledge database 204 may also be co-located with the KM tool 201. The KM tool 201 may enable the user to provide an access level associated with the item, wherein the level of access may be restricted to a project, a technology group, the entire organization and so on.

The server 101 may generate at least one keyword based on the item and may perform a search on the external source using the generated keywords. The server 101 may also store items from the external source along with the item as uploaded by the user 103 in the knowledge database 204.

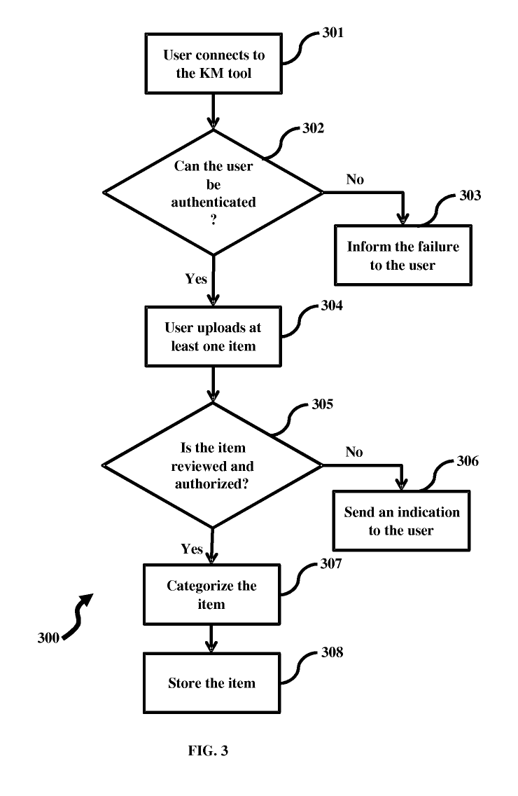

FIG. 3 is a flowchart illustrating the process of at least one user uploading at least one item of knowledge to a knowledge database repository, according to embodiments as disclosed herein. On a user 103 connecting (301) to the KM tool 201, the KM tool 201 authenticates (302) the user 103. The KM tool 201 may check if the user 103 has the requisite permissions to upload items to the server 101. If the user cannot be authenticated, the KM tool 201 informs (303) the failure to the user 103. On the user 103 being authenticated, the user 103 uploads (304) at least one item to the KM tool 101. If the subject matter expert reviews (305) the item and does not authorize the upload of the item, the KM tool 201 sends (306) an indication to the user 103. The indication may comprise at least one reason, if provided by the subject matter expert on why the item was not authorized. On the subject matter expert reviewing (305) the item and authorizing the upload of the item, the KM tool 201 categorizes (307) the item into at least one hierarchy. The KM tool 201 then stores (308) the item in the knowledge database 204. The various actions in method 300 may be performed in the order presented, in a different order or simultaneously. Further, in some embodiments, some actions listed in FIG. 3 may be omitted.

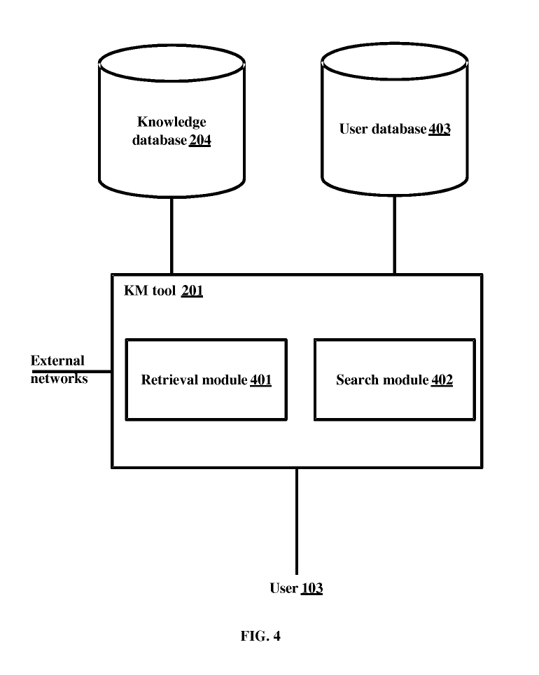

FIG. 4 depicts a system for enabling at least one user to access an item from the knowledge database repository, according to embodiments as disclosed herein. The system, as depicted, comprises of a KM tool 201 (comprising of a retrieval module 401 and a search module 402) connected to the knowledge database 204 and at least one user database 403. On detecting a change in the information of a user (such as a new project with new technology being assigned to the user, a new lifecycle in the project to which the user belongs and so on), the retrieval module 401 may check for any item from the knowledge database 204 that may be made available to the user 103. The retrieval module 401 check for the item(s) based on a plurality of factors such as the technology that the user is currently working on, the technology that the user may be working on in the future, the current phase of the PDLC, the skill levels of the user 103, the previous employment history of the user 103 (such as the previous items that the user 103 has been exposed to, the educational history of the user 103, the previous projects that the user 103 has worked on, the previous organizations that the user has worked in, the time the employee has been employed with the current organization and so on), the role played by the user 103 in the project and so on. On detecting at least one item that may be made available to the user 103, the retrieval module 401 makes the item(s) available to at least one person to whom the user reports, to verify the item, before the server 101 provides the item to the user 103.

The search module 402 may enable the user 101 to search for item(s) using at least one keyword/keyphrase through a user interface. Based on the keyword/keyphrase, the search module 402 may provide at least one result from the items present in the knowledge database 204. In an embodiment herein, the search module 402 may consider factors such as the technology that the user is currently working on, the technology that the user may be working on in the future, the current phase of the PDLC, the skill levels of the user 103, the previous employment history of the user 103 (such as the previous items that the user 103 has been exposed to, the educational history of the user 103, the previous projects that the user 103 has worked on, the previous organizations that the user has worked in, the time the employee has been employed with the current organization and so on), the role played by the user 103 in the project and so on, before providing the results to the user.

The KM tool 201 may enable the user 103 receiving the item(s) to verify that he has completed the course. The user 103 may verify using a signature (which may be an electronic signature, where he writes his name, the current date and so on).

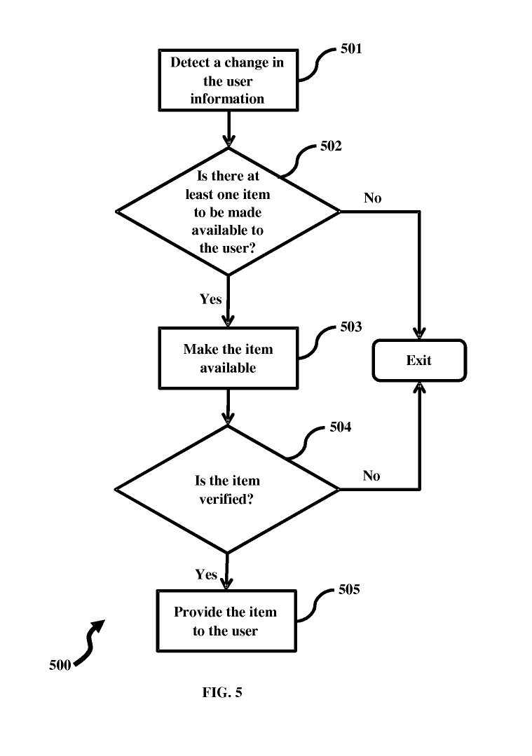

FIG. 5 is a flowchart illustrating the process of providing at least one item of knowledge from a knowledge database repository to a user automatically, according to embodiments as disclosed herein. On detecting (501) a change in the information of a user (such as a new project with new technology being assigned to the user, a new lifecycle in the project to which the user belongs and so on), the KM tool 201 checks (502) for any item from the knowledge database 204 that may be made available to the user 103. The KM tool 201 may check for the item(s) based on a plurality of factors such as the technology that the user is currently working on, the technology that the user may be working on in the future, the current phase of the PDLC, the skill levels of the user 103, the history of the user 103 (such as the previous items that the user 103 has been exposed to, the educational history of the user 103, the previous projects that the user 103 has worked on, the previous organizations that the user has worked in, the time the employee has been employed with the current organization and so on), the role played by the user 103 in the project and so on. On detecting at least one item that may be made available to the user 103, the retrieval module 401 makes (503) the item(s) available to at least one person to whom the user reports, to verify (504) the item, before the server 101 provides (505) the item to the user 103. The retrieval module 401 may provide items from the external source along with the item to the user. The various actions in method 500 may be performed in the order presented, in a different order or simultaneously. Further, in some embodiments, some actions listed in FIG. 5 may be omitted.

Embodiments herein enable automatically providing the knowledge to the users based on the technology & lifecycle activity that the user is supposed to execute during the course of his project. Embodiments disclosed herein enable saving compliances as knowledge in the KM tool Embodiments disclosed herein enable maintaining the skill levels for each engineer and using the knowledge of the skill levels for relevant trainings from the KM tool directly. Embodiments disclosed herein may be used to monitor compliance and auditing purposes, as the user may sign an item accessed by the user.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for providing knowledge present in an organization to at least one employee, the method comprising of
checking by a knowledge management (KM) tool if at least one item of knowledge is to be provided to a user, on detecting a change in information of the user; and
providing at least one item of knowledge to the user by the KM tool, on the KM tool detecting at least one item of knowledge that is to be provided to a user.

2. The method, as claimed in claim 1, wherein the method further comprises of a user in the organization uploading at least one item of knowledge to the KM tool.

3. The method, as claimed in claim 1, wherein the KM tool decides if at least one item of knowledge is to be provided based on the technology that the user is currently working on, the current lifecycle of a project which the user is working on, the technology that the user may be working on in the future, the skill levels of the user, the history of the user, and the role played by the user in the project.

4. The method, as claimed in claim 1, wherein the method further comprises of verifying the at least one item of knowledge by another user, before providing the at least one item of knowledge to the user.

5. The method, as claimed in claim 1, wherein the method further comprises of providing at least one item from an external source to the user, wherein the at least one item from an external source may be associated with the item of knowledge provided to the user.

6. A knowledge management (KM) system for providing knowledge present in an organization to at least one employee, the system configured for
checking if at least one item of knowledge is to be provided to a user, on detecting a change in information of the user; and
providing at least one item of knowledge to the user, on the system detecting at least one item of knowledge that is to be provided to a user.

7. The knowledge management system, as claimed in claim 6, wherein the system is further configured to enable a user in the organization to upload at least one item of knowledge to a KM tool.

8. The knowledge management system, as claimed in claim 6, wherein the system is further configured to decide if at least one item of knowledge is to be provided based on the technology that the user is currently working on, the current lifecycle of a project which the user is working on, the technology that the user may be working on in the future, the skill levels of the user, the history of the user, and the role played by the user in the project.

9. The knowledge management system, as claimed in claim 6, wherein the system is further configured to verify the at least one item of knowledge with another user, before providing the at least one item of knowledge to the user.

10. The knowledge management system, as claimed in claim 6, wherein the system is further configured to provide at least one item from an external source to the user, wherein the at least one item from an external source may be associated with the item of knowledge provided to the user.
